(19) United States
(12) Patent Application Publication
(10) Pub. No.: US 2019/0270341 A1
(43) Pub. Date: Sep. 5, 2019

(54) Tire Tread For A Heavy Civil-Engineering Vehicle

(71) Applicant: COMPAGNIE GENERALE DES ETABLISSEMENTS MICHELIN, Clermont-Ferrand (FR)

(72) Inventors: Olivier SPINNLER, Clermont-Ferrand (FR); Julien CLADIERE, Clermont-Ferrand (FR)

(21) Appl. No.: 16/338,122

(22) PCT Filed: Oct. 5, 2017
(86) PCT No.: PCT/FR2017/052733

§ 371 Date: Mar. 29, 2019

(30) Foreign Application Priority Data
Oct. 7, 2016 (FR) 1659672

(51) Int. Cl. B60C 1/00; B60C 11/03; B60C 11/13; B60C 11/00

(52) U.S. Cl. CPC B60C 1/0016; B60C 11/033; B60C 11/1353; B60C 2011/0334; B60C 2011/0025; B60C 2011/0033; B60C 2200/065; B60C 11/005

(57) ABSTRACT

A radial tire intended to be fitted to a heavy vehicle of construction plant type, and more particularly to the tread thereof. The tread of such a tire is desensitized to attack by indenting bodies that are likely to cause cracks at the cut bottom, in particular in the case of a tread with a high volumetric void ratio and a high degree of surface siping. Such a tire has a degree of surface siping TL of the tread at least equal to 3 m/m², a number of cycles to failure N_{R} of the elastomeric compound of the tread, at least present at the cut bottom, at least equal to 60000 cycles, and a ratio C between the number of cycles to failure N_{R} of the elastomeric compound and the degree of surface siping TL at least equal to 20000 cycles/(m/m²).

The present invention relates to a radial tire intended to be fitted to a heavy vehicle of construction plant type, and more particularly to the tread of such a tire.

A radial tire for a heavy vehicle of construction plant type is intended to be fitted on a rim, the nominal diameter of which, within the meaning of the ETRTO (European Tire and Rim Technical Organisation) standard, is at least equal to 25 inches. Although not restricted to this type of application, the invention is described more particularly with reference to a radial tire of large size intended to be mounted, for example, on a dumper, a vehicle for transporting materials extracted from quarries or open cast mines. A radial tire of large size is understood to be a tire intended to be mounted on a rim, the nominal diameter of which is at least equal to 49 inches and may be as much as 57 inches or even 63 inches.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively.

In the following text, the expressions “radially inner” and “radially outer” mean “closer to” and “further away from the axis of rotation of the tire”, respectively. “Axially inside” and “axially outside” mean “closer to” and “further away from the equatorial plane of the tire”, respectively, the equatorial plane of the tire being the plane passing through the middle of the tread surface of the tire and perpendicular to the axis of rotation of the tire.

A radial tire comprises, radially from the outside to the inside, a tread, a crown reinforcement and a carcass reinforcement. The assembly made up of the tread and the crown reinforcement is the crown of the tire.

The tread is that part of the tire that is intended to come into contact with the ground via a tread surface and to be worn away.

The tread comprises a more or less complex system of cuts separating elements in relief, referred to as tread pattern, for ensuring notably a satisfactory grip performance.

The cuts in the tread may have any type of orientation with respect to the circumferential direction of the tire. A distinction is usually made between the longitudinal or circumferential cuts that form an angle at most equal to 45° with the circumferential direction and the axial or transverse cuts that form an angle at least equal to 45° with the circumferential direction. Among the cuts, grooves and sipes are distinguished. A groove is a cut that defines a space delimited by facing walls of material that are spaced apart from one another such that said walls cannot come into contact with one another in the contact patch in which the tread is in contact with the ground, when the tire is running under recommended nominal load and pressure conditions. A sipe is a cut that defines a space delimited by walls of material that come into contact with one another during running.

The tread is generally characterized geometrically by an axial width W_{T} and a radial thickness H_{T}. The axial width W_{T} is defined as being the axial width of the contact surface of the tread of the new tire with smooth ground, the tire being subjected to pressure and load conditions as recommended, for example, by the E.T.R.T.O. (European Tire and Rim Technical Organization) standard. The radial thickness H_{T} is defined, by convention, as being the maximum radial depth measured in the cuts. In the case of a tire for a heavy vehicle of construction plant type, and by way of example, the axial width W_{T} is at least equal to 600 mm and the radial thickness H_{T} is at least equal to 60 mm.

The tread is also frequently characterized by a volumetric void ratio TEV equal to the ratio between the total volume V_{D} of the cuts, measured on the unconstrained tire, that is to say on the tire when it is not mounted and not inflated, and the sum of the total volume V_{D} of the cuts and the total volume V_{R} of the elements in relief delimited by these cuts. The sum V_{D}+V_{R} corresponds to the volume contained radially between the tread surface and a bottom surface, translated from the tread surface radially inwards by a radial distance equal to the radial thickness H_{T} of the tread. This volumetric void ratio TEV, expressed in %, governs in particular the wearing performance, through the volume of wearable rubber available, and the longitudinal and transverse grip performance, through the presence of respectively transverse and longitudinal edge corners and of cuts capable of storing or removing water or mud.

In the present invention, cuts of which the width W_{D} is at most equal to 20% of their radial depth H_{D} and of which the radial depth H_{D} is at least equal to 50% of the radial thickness H_{T} of the tread are referred to as effective cuts. These are cuts of the groove type, allowing air to flow in the tread, and not sipes.

These effective cuts, having a cumulative length L_{D}, measured on a radially outer surface of the tread, make it possible to define a degree of surface siping TL, expressed in m/m², equal to the ratio between the cumulative length L_{D} of the effective cuts and the area A of the radially outer surface of the tread equal to 2ΠR_{E}*W_{T}, where R_{E} is the external radius of the tire.

The tread of a tire also comprises at least one elastomeric compound, that is to say an elastomeric material obtained by mixing the various constituents thereof. An elastomeric compound conventionally comprises an elastomeric matrix comprising at least one diene elastomer of the natural or synthetic rubber type, at least one reinforcing filler of the carbon black type and/or of the silica type, a usually sulfur-based crosslinking system, and protective agents.

An elastomeric compound may be characterized mechanically, in particular after curing, by its dynamic properties, such as a dynamic shear modulus G*=(G′²+G″²)^{1/2}, wherein G′ is the elastic shear modulus and G″ is the viscous shear modulus, and a dynamic loss tgδ=G″/G′. The dynamic shear modulus G* and the dynamic loss tgδ are measured on a viscosity analyser of the Metravib VA4000 type according to Standard ASTM D 5992-96. The response of a sample of vulcanized elastomeric compound in the form of a cylindrical test specimen with a thickness of 4 mm and a cross section of 400 mm², subjected to a simple alternating sinusoidal shear stress, at a frequency of 10 Hz, with a deformation amplitude sweep from 0.1% to 45% (outward cycle) and then from 45% to 0.1% (return cycle), at a temperature of 100° C., is recorded. These dynamic properties are thus measured for a frequency equal to 10 Hz, a deformation equal to 50% of the peak-to-peak deformation amplitude, and a temperature equal to 100° C.

An elastomeric compound can also be characterized in terms of its crack resistance, by a fatigue test. The fatigue strength N_{R}, expressed as number of cycles or in relative units (percentage of a number of cycles with respect to a reference number of cycles), is measured on 12 test specimens subjected to repeated low-frequency tensile deformations up to an elongation of 40%, at a temperature of 23° C., using a Monsanto (MFTR type) machine until the test specimen breaks, applying the protocol described in the ASTM D4482-85 and ISO 6943 standards to rectangular test specimens (useful length 65 mm, thickness 1.5 mm, width 15 mm) having a central notch of 3 mm. With results expressed in relative units, a value greater than that of a control taken as a reference, arbitrarily set at 100, indicates an improved result, that is to say a better fatigue strength of the samples of elastomeric compound. Correspondingly, a value lower than 100 indicates an inferior result, that is to say less good fatigue strength of the samples of elastomeric compound.

It is known that the crack resistance of an elastomeric compound depends in particular on the homogeneity of the mixing of its constituents, in particular of the elastomeric matrix and the reinforcing filler. A known homogeneity criterion is the dispersion of the reinforcing filler in the elastomeric matrix.

The dispersion of reinforcing filler in an elastomeric matrix is characterized in a known manner by a dispersion coefficient Z, which is measured, after crosslinking of the elastomeric compound, using the method described by S. Otto et al. in Kautschuk Gummi Kunststoffe, 58 Jahrgang, NR 7-8/2005, in accordance with standard ISO 11345.

The calculation of the coefficient Z is based on the percentage of surface area in which the reinforcing filler is not dispersed (“% undispersed surface area”), as measured by the “disperGRADER+” device supplied, with its operating instructions and “disperDATA” operating software, by Dynisco, according to the equation:

Z=100−(% undispersed surface area)/0.35

The percentage of undispersed surface area is, for its part, measured using a camera which observes the surface of the sample under incident light at 30°. The light points are associated with reinforcing filler and with agglomerates, while the dark points are associated with the elastomeric matrix; digital processing converts the image into a black and white image and makes it possible to determine the percentage of undispersed surface area, as described by S. Otto in the abovementioned document.

The higher the coefficient Z, the better the dispersion of the reinforcing filler in the elastomeric matrix, a coefficient Z equal to 100 corresponding to perfect dispersion and a coefficient Z equal to 0 corresponding to mediocre dispersion. A coefficient Z greater than or equal to 65 will be deemed to correspond to good dispersion of the reinforcing filler in the elastomeric matrix.

The use of a tire for a heavy vehicle of construction plant type is characterized by the tire bearing high loads and running on tracks covered with stones of various sizes. When the tire is running under high load on tracks covered with stones, which will indent the tread, the indenting bodies will attack the tread and also possibly become trapped in the cuts in the tread. The trapping of the stones in the cuts in the tread, also referred to as stone retention, is likely to initiate cracks at the bottom of cuts, which will propagate radially towards the inside of the crown of the tire, reaching the crown reinforcement, and more specifically the radially outermost protective reinforcement, which will deteriorate over time and break: this will reduce the service life of the tire. This phenomenon is all the more marked the greater the number and/or the greater the volume of the cuts in the tread, i.e. the higher the volumetric void ratio of the tread, typically at least equal to 12%, and the higher the degree of surface siping, typically at least equal to 3%.

The inventors have set themselves the objective of desensitizing the tread of a tire for a heavy vehicle of construction plant type to attack by indenting bodies that are likely to cause cracks at the cut bottom, in particular in the case of a tread with a high volumetric void ratio and a high degree of surface siping.

This objective has been achieved by a tire for a heavy vehicle of construction plant type, comprising:
a tread having a radial thickness H_{T} at least equal to 60 mm and an axial width W_{T},
the tread comprising cuts having a width W_{D} and a radial depth H_{D}, and elements in relief that are separated from one another by the cuts,
the cuts, the width W_{D} of which is at most equal to 20% of their radial depth H_{D} and the radial depth H_{D} of which is at least equal to 50% of the radial thickness H_{T} of the tread, referred to as effective cuts, having a cumulative length L_{D} measured on a radially outer surface of the tread,
the tread having a degree of surface siping TL, expressed in m/m², equal to the ratio between the cumulative length L_{D} of the effective cuts and the area A of the radially outer surface of the tread equal to 2ΠR_{E}*W_{T}, where R_{E} is the external radius of the tire,
the tread comprising, at least at the bottoms of the cuts, an elastomeric compound having a crack resistance defined by a number of cycles to failure N_{R},
the degree of surface siping TL of the tread being at least equal to 3 m/m²,
the number of cycles to failure N_{R} of the elastomeric compound of the tread being at least equal to 60000 cycles,
and the ratio C between the number of cycles to failure N_{R} of the elastomeric compound of the tread and the degree of surface siping TL of the tread being at least equal to 20000 cycles/(m/m²).

A first essential characteristic of the invention is that of having a degree of surface siping TL of the tread at least equal to 3 m/m². Such a degree of surface siping TL of the tread, that is to say such a minimum cumulative length L_{D} of the effective cuts per unit of surface area, causes a high risk of stones being trapped in the effective cuts. On the other hand, it ensures good grip of the tire, and also ventilation of the effective cuts in the tread, and thus cooling of the tread and, consequently, a reduction in the internal temperatures of the crown.

A second essential characteristic of the invention is that of having a number of cycles to failure N_{R} of the elastomeric compound of the tread at least equal to 60000 cycles. Such a number of cycles to failure, which is characteristic of a moderate rate of propagation of cracks, ensures a satisfactory crack resistance of the elastomeric compound, at least in the cut bottoms that are particularly exposed to the indenting bodies present on the ground on which the tire runs.

The inventors have finally shown that a ratio C between the number of cycles to failure N_{R} of the elastomeric compound of the tread and the degree of surface siping TL of the tread at least equal to 20000 cycles/(m/m²), combined with the two characteristics of siping of the tread and crack resistance of the elastomeric compound, was a relevant criterion for good resistance of the tread to attack by indenting bodies likely to create cracks at the bottom of cuts, in the case of a tread with a large number of cuts, with a high volumetric void ratio and a high degree of surface siping.

Advantageously, the ratio C is at least equal to 40000 cycles/(m/m²). Such a ratio further reinforces the resistance to attack of the tread.

Advantageously, the degree of siping TL of the tread is at least equal to 3.5 m/m². The risk of stones becoming trapped in the cuts is further increased, but the grip is improved. Moreover, the ventilation of the effective cuts in the tread is improved by a higher degree of siping TL, this resulting in a decrease in the heat level of the crown of the tire and consequently allowing greater productivity in terms of the transport of materials carried out by vehicles equipped with tires according to the invention.

Further advantageously, the degree of siping TL of the tread is at most equal to 9 m/m². Above this degree of siping TL, the cumulative length L_{D} of effective cuts per unit of surface area, and consequently the number of effective cuts per unit of surface area, risks sensitizing the tread to attack to an unacceptable degree. Not only does the number of regions of initiation of cracks at the bottom of cuts become too high, but also, on account of the large number of cuts, the dimensions of the elements in relief decrease and thus the stiffnesses thereof decrease, thereby increasing the risk of the elements in relief tearing.

Preferably, the number of cycles to failure N_{R} of the elastomeric compound of the tread is at least equal to 120000 cycles, Such a number of cycles to failure further reinforces the resistance of the elastomeric compound of the tread to attack.

It is advantageous for the elastomeric compound of the tread to have a dynamic shear modulus G* at least equal to 1.0 MPa. A minimum stiffness of the material ensures a satisfactory wear resistance of the elastomeric compound of the tread.

It is also advantageous for the elastomeric compound of the tread to have a dynamic loss tgδ at most equal to 0.2. A dynamic loss that is not too high makes it possible to limit the heat level of the crown. Such a level of heat loss is more particularly characteristic of elastomeric compounds of which the elastomeric matrix consists of natural rubber.

According to a preferred embodiment of its composition, the elastomeric compound of the tread comprises an elastomeric matrix consisting of a natural polyisoprene. As seen above, this type of material makes it possible in particular to ensure limited heat levels in the crown of the tire.

The elastomeric compound of the tread preferably comprises a reinforcing filler, the content of which is at least equal to 25 phr (parts per hundred parts of elastomer) and at most equal to 80 phr. This range of the content of reinforcing filler allows a good compromise between the wear resistance and the resistance to attack.

According to a first composition variant, the reinforcing filler of the elastomeric compound of the tread comprises a carbon black, the content of which is at least equal to 25 phr and at most equal to 60 phr. Specifically, carbon black is the reinforcing filler most used in elastomeric compounds.

According to a second composition variant, the reinforcing filler of the elastomeric compound of the tread comprises an inorganic filler, preferably a silica, the content of which is at most equal to 25 phr. A conventional inorganic filler is silica.

With the reinforcing filler of the elastomeric compound of the tread having a dispersion coefficient Z, the dispersion coefficient Z of the reinforcing filler of the elastomeric compound of the tread is preferably at least equal to 65. The higher the dispersion coefficient Z, the more homogeneous the dispersion of the reinforcing filler in the elastomeric compound: this being favourable as regards resistance to attack.

According to a common embodiment, the tread is made up of a single elastomeric compound.

Advantageously, with the set of cuts having a total volume V_{D} and the set of elements in relief having a total volume V_{R}, the tread having a volumetric void ratio TEV, expressed in %, equal to the ratio between the total volume V_{D} of the cuts and the sum of the total volume V_{D} of the cuts and the total volume of the elements in relief, the volumetric void ratio TEV of the tread is at least equal to 12%, preferably at least equal to 14%. In order to have effective thermal ventilation of the tread, the cuts need to be sufficient in number, this resulting in a minimum degree of siping TL, and to have a sufficient volume, this resulting in a minimum volumetric void ratio TEV. Moreover, a minimum volumetric void ratio TEV is favourable for the grip of the tire, facilitating the evacuation of water and mud that may be present on the tracks run on.

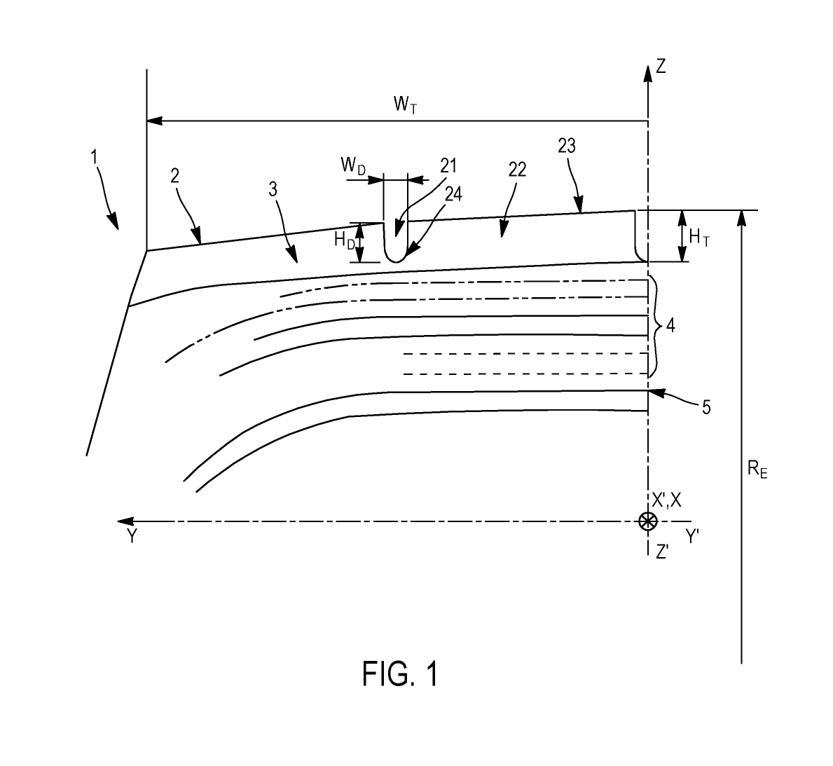

The features of the invention will be better understood with the aid of FIGS. 1 to 3, which are schematic and not to scale:

FIG. 1 is a half-section, on a meridian plane, of a crown of a tire for a heavy vehicle of construction plant type, according to the invention.

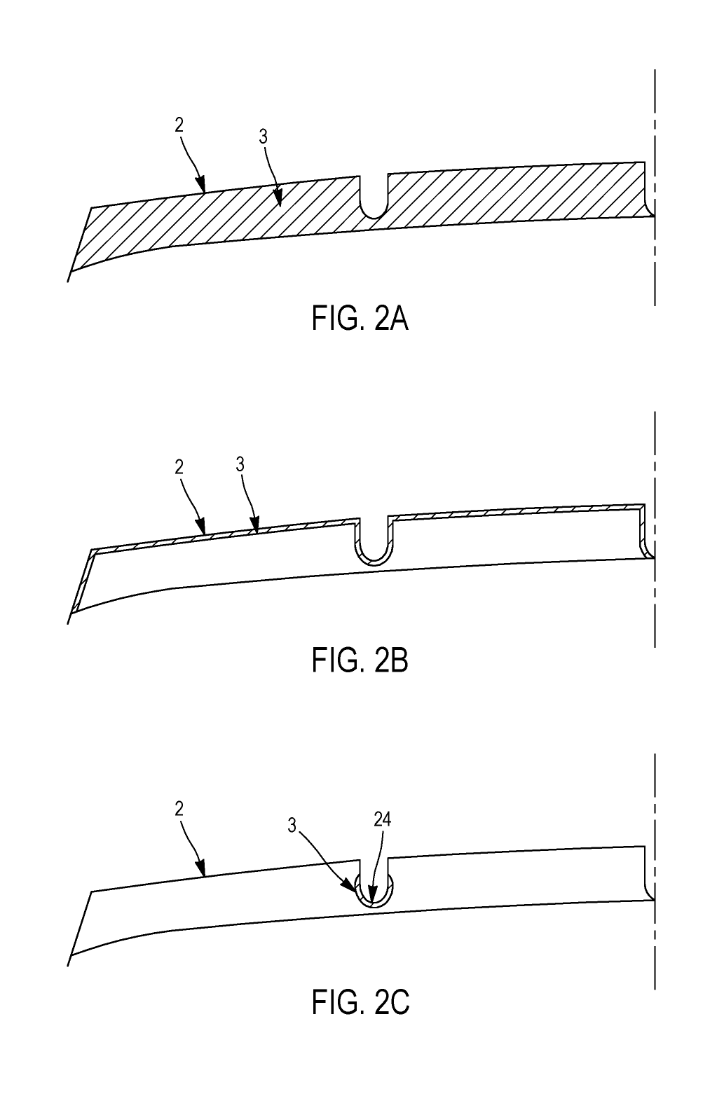

FIGS. 2A to 2C show embodiment variants of a tread for a tire for a heavy vehicle of construction plant type, according to the invention.

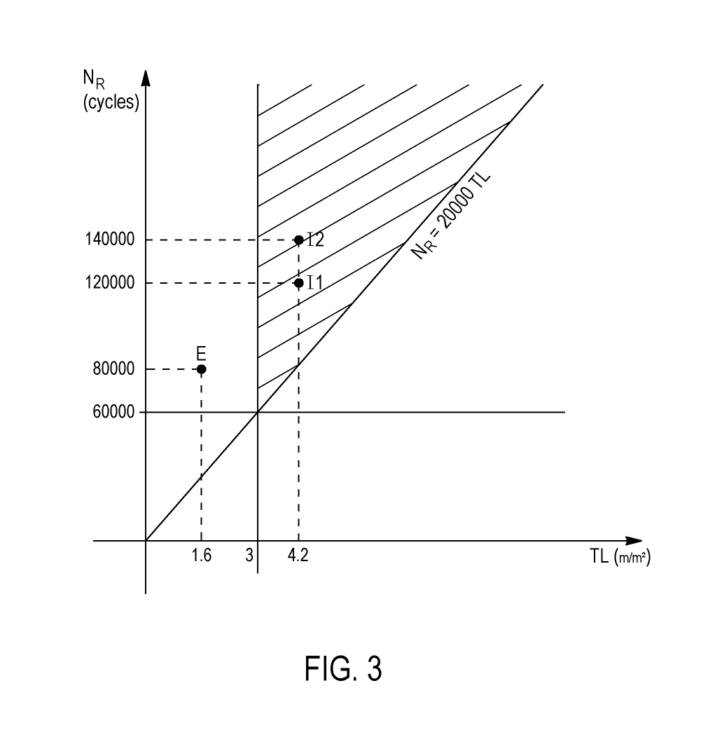

FIG. 3 shows the range of the number of cycles to failure N_{R} of the elastomeric compound of the tread as a function of the degree of surface siping TL of the tread for a tire for a heavy vehicle of construction plant type according to the invention.

FIG. 1 shows a meridian half-section, in a plane YZ, of the crown of a tire 1 for a heavy vehicle of construction plant type, comprising a tread 2 and a crown reinforcement 3 radially on the inside of the tread 2. The tread 2, having a radial thickness H_{T} at least equal to 60 mm, comprises cuts 21 having a width W_{D} and a radial depth H_{D}, and elements in relief 22 separated by the cuts 21. The cuts 21, the width W_{D} of which is at most equal to 20% of the radial depth H_{D} thereof, measured between a radially outer surface 23 of the tread 2 and a cut bottom 24, and the radial depth H_{D} of which is at least equal to 50% of the radial thickness H_{T}, referred to as effective cuts, have a cumulative length L_{D} (not shown in the figure) measured on the radially outer surface 23 of the tread 2. The tread 2 has a degree of surface siping TL, expressed in m/m², equal to the ratio between the cumulative length L_{D} of the effective cuts 21 and the area A of the radially outer surface 23 of the tread equal to 2ΠR_{E}*W_{T}, where R_{E} is the external radius of the tire, measured in the equatorial plane XZ, between the axis of revolution YY′ and the radially outer surface 23 of the tread 2 or tread surface. Radially on the inside of the tread 2, the crown reinforcement 3 comprises, radially from the outside to the inside, a protective reinforcement made up of two protective layers, a working reinforcement made up of two working layers, and a hoop reinforcement made up of two hooping layers.

FIGS. 2A to 2C show embodiment variants of a tread for a tire for a heavy vehicle of construction plant type, according to the invention. Only one half-tread, in a meridian plane, is shown. FIG. 2A shows a tread 2 made up of a single elastomeric compound 3, which is resistant to cracking within the meaning of the invention, i.e. is characterized by a number of cycles to failure N_{R} at least equal to 60000 cycles. FIG. 2B shows a tread 2, a radially outer portion of which is made up of an elastomeric compound 3 that is resistant to cracking within the meaning of the invention. Finally, FIG. 2C shows the case in which the elastomeric compound 3 that is resistant to cracking within the meaning of the invention is only located at a cut bottom 24.

FIG. 3 shows the range of the number of cycles to failure N_{R} of the elastomeric compound of the tread as a function of the degree of surface siping TL of the tread for a tire for a heavy vehicle of construction plant type according to the invention. According to the invention, the degree of surface siping TL of the tread is at least equal to 3 m/m², and the number of cycles to failure N_{R} of the elastomeric compound of the tread is at least equal to 60000 cycles, with a ratio C between the number of cycles to failure N_{R} and the degree of surface siping TL at least equal to 20000 cycles/(m/m²). Consequently, the range of the invention, which is hatched in FIG. 3, is delimited by the straight lines TL=3 m/m² and N_{R}=C*TL=20000*TL cycles/(m/m²). The graph in FIG. 3 shows an example of the prior art E, outside the range of the invention, characterized by a degree of surface siping TL equal to 1.6 m/m², i.e. less than 3 m/m², and a number of cycles to failure N_{R} equal to 80000 cycles. Also shown are two exemplary embodiments of the invention, I1 and I2, for which the degree of surface siping TL is equal to 4.2 m/m², and having a number of cycles to failure N_{R} equal to 120000 cycles and to 140000 cycles, respectively.

The invention has been studied more particularly in the case of a tire of size 40.00R57. Two examples of tires according to the invention I1 and I2 and a tire of the prior art E, taken as a reference, were compared by the inventors.

The respective features of siping and of the elastomeric compound of the tread of the tire E and of the tires I1 and I2 are set out in Table 1 below.

TABLE 1

| Tire size | | | I1 (40.00R57) | | I2 (40.00R57) | |
|---|---|---|---|---|---|---|
| Degree of | 1.6 | m/m² | 4.2 | m/m² | 4.2 | m/m² |
| surface | | | | | | |
| siping TL | | | | | | |
| Elastomeric | polyisoprene | | polyisoprene | | polyisoprene | |
| matrix | | | | | | |
| Content of | Carbon black: | | Carbon black: | | Carbon black: | |
| reinforcing | 40 phr | | 42 phr | | 35 phr | |
| filler | Silica: 15 phr | | Silica: 15 phr | | Silica: 10 phr | |
| Dynamic shear | 1.4 | MPa | 1.4 | MPa | 1.2 | MPa |
| modulus G* | | | | | | |
| Dynamic loss | 0.14 | | 0.14 | | 0.07 | |
| tgδ | | | | | | |
| Dispersion | 55 | | 75 | | 65 | |
| coefficient Z | | | | | | |
| of the rein- | | | | | | |
| forcing filler | | | | | | |
| Number of | 80000 | cycles | 120000 | cycles | 140000 | cycles |
| cycles to | | | | | | |
| failure N_{R} | | | | | | |

| | | | |
|---|---|---|---|
| Ratio C = | 50000 cycles/ | 28571 cycles/ | 33333 cycles/ |
| N_{R}/TL | (m/m²) | (m/m²) | (m/m²) |

According to Table 1, the three tires compared E, I1 and I2 have a tread made up of a single elastomeric compound, the elastomeric matrix of which is a polyisoprene, that is to say a natural rubber, and the reinforcing filler of which comprises both a carbon black and an inorganic filler of the silica type. The tire E of the prior art does not fall within the scope of the invention since it does not meet the criterion of minimum degree of surface siping TL at least equal to 3 m/m², that is to say of a tread with a sufficient number of cuts. By contrast, the degree of surface siping TL of the tires I1 and I2 is equal to 4.2 m/m² and thus meets this criterion. The elastomeric compound of the tread of the tire I1 is both stiffer and has greater hysteresis than that of the tire I2. Furthermore, the reinforcing filler for the tire I1 is more dispersed than for the tire I2. However, with the number of cycles to failure N_{R} being lower for the tire I1 than for the tire I2, with the degree of siping TL being the same, the ratio C is lower for the tire I1 than for the tire I2. Therefore, the tire I2 performs better than the tire I1 as regards resistance to attack.

1. A tire for a heavy vehicle of construction plant type, comprising:
a tread having a radial thickness H_{T} at least equal to 60 mm and an axial width W_{T},
the tread comprising cuts having a width W_{D} and a radial depth H_{D}, and elements in relief that are separated from one another by the cuts,
wherein the cuts, the width W_{D} of which is at most equal to 20% of their radial depth H_{D} and the radial depth H_{D} of which is at least equal to 50% of the radial thickness H_{T} of the tread, referred to as effective cuts, have a cumulative length L_{D} measured on a radially outer surface of the tread,
the tread having a degree of surface siping TL, expressed in m/m², equal to the ratio between the cumulative length L_{D} of the effective cuts and the area A of the radially outer surface of the tread equal to 2□R_{E}*W_{T}, where R_{E} is the external radius of the tire,
the tread comprising, at least at the bottoms of the cuts, an elastomeric compound having a crack resistance defined by a number of cycles to failure N_{R},
wherein the degree of surface siping TL of the tread is at least equal to 3 m/m², wherein the number of cycles to failure N_{R} of the elastomeric compound of the tread is at least equal to 60000 cycles, and wherein the ratio C between the number of cycles to failure N_{R} of the elastomeric compound of the tread and the degree of surface siping TL of the tread is at least equal to 20000 cycles/(m/m²).

2. The tire for a heavy vehicle of construction plant type according to claim 1, wherein the ratio C is at least equal to 40000 cycles/(m/m²).

3. The tire for a heavy vehicle of construction plant type according to claim 1, wherein the degree of siping TL of the tread is at least equal to 3.5 m/m².

4. The tire for a heavy vehicle of construction plant type according to claim 1, wherein the degree of siping TL of the tread is at most equal to 9 m/m².

5. The tire for a heavy vehicle of construction plant type according to claim 1, wherein the number of cycles to failure N_{R} of the elastomeric compound of the tread is at least equal to 120000 cycles.

6. The tire for a heavy vehicle of construction plant type according to claim 1, wherein the elastomeric compound of the tread has a dynamic shear module G* at least equal to 1.0 MPa.

7. The tire for a heavy vehicle of construction plant type according to claim 1, wherein the elastomeric compound of the tread has a dynamic loss tgδ at most equal to 0.2.

8. The tire for a heavy vehicle of construction plant type according to claim 1, wherein the elastomeric compound of the tread comprises an elastomeric matrix consisting of a natural polyisoprene.

9. The tire for a heavy vehicle of construction plant type according to claim 1, wherein the elastomeric compound of the tread comprises a reinforcing filler, the content of which is at least equal to 25 phr (part per hundred parts of elastomer) and at most equal to 80 phr.

10. The tire for a heavy vehicle of construction plant type according to claim 9, wherein the reinforcing filler of the elastomeric compound of the tread comprises a carbon black, the content of which is at least equal to 25 phr and at most equal to 60 phr.

11. Tire for a heavy vehicle of construction plant type according to claim 9, wherein the reinforcing filler of the elastomeric compound of the tread comprises an inorganic filler, the content of which is at most equal to 25 phr.

12. The tire for a heavy vehicle of construction plant type according to claim 9, the reinforcing filler of the elastomeric compound of the tread having a dispersion coefficient Z, wherein the dispersion coefficient Z of the reinforcing filler of the elastomeric compound of the tread is at least equal to 65.

13. The tire for a heavy vehicle of construction plant type according to claim 1, wherein the tread is made up of a single elastomeric compound.

14. The tire for a heavy vehicle of construction plant type according to claim 1, the set of cuts having a total volume V_{D} and the set of elements in relief having a total volume V_{R}, the tread having a volumetric void ratio TEV, expressed in %, equal to the ratio between the total volume V_{D} of the cuts and the sum of the total volume V_{D} of the cuts and the total volume of the elements in relief, wherein the volumetric void ratio TEV of the tread is at least equal to 12%.

15. The tire for a heavy vehicle of construction plant type according to claim 9, wherein the reinforcing filler of the elastomeric compound of the tread comprises a silica, the content of which is at most equal to 25 phr.

16. The tire for a heavy vehicle of construction plant type according to claim 1, the set of cuts having a total volume V_{D} and the set of elements in relief having a total volume V_{R}, the tread having a volumetric void ratio TEV, expressed in %, equal to the ratio between the total volume V_{D} of the cuts and the sum of the total volume V_{D} of the cuts and the total volume of the elements in relief, wherein the volumetric void ratio TEV of the tread is at least equal to 14%.
